(19) United States
(12) Patent Application Publication
(10) Pub. No.: US 2009/0027998 A1
(43) Pub. Date: Jan. 29, 2009

(54) Magnetic mixer

(75) Inventors: Folim G. Halaka, Lake Forest, IL (US); Scott G. Safar, Burlington, WI (US)

Correspondence Address: VYSIS, INC;PATENT DEPARTMENT, 1300 E TOUHY AVENUE, DES PLAINES, IL, 60018, US

(73) Assignee: Abbott Laboratories, Des Plaines, IL (US)

(21) Appl. No.: 12/220,417

(22) Filed: Jul. 24, 2008

Related U.S. Application Data
(60) Provisional application No. 60/962,136, filed on Jul. 25, 2007.

(51) Int. Cl. B01F 13/08

(52) U.S. Cl. 366/341

(57) ABSTRACT

A device facilitating mixing of a fluid containing magnetic or magnetizable particles, including a support for a container for the fluid and particles, a first magnet adjacent one side of the support, a second magnet adjacent the other side, and a drive for moving the second magnet between a first position near the container top and a second position near the container bottom. The first magnet is supported in a third position on the one side near the container bottom. A related tray and method for mixing magnetic particles are also disclosed.

### CROSS REFERENCE TO RELATED APPLICATION(S)

This application claims priority of provisional application Ser. No. 60/962,136, filed Jul. 25, 2007, entitled “Magnetic Mixer.”

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention is directed toward mixing fluids, and particularly toward mixing fluids having magnetic or magnetizable particles therein.

### BACKGROUND OF THE INVENTION AND TECHNICAL PROBLEMS POSED BY THE PRIOR ART

In biological testing, for example, various substances may be found in a fluid containing a biological specimen with it being necessary or desirable to isolate or remove certain of those substances in order to perform some test.

In many instances, it has been found to be advantageous to include magnetic or magnetizable particles in the fluid, where the particles have binding properties which cause selected substances to bind to the particles when they come in contact in the fluid. The particles (and the substance bound to the particles) may then be removed from the fluid materials by drawing the particles to the side of the fluid container using one or more magnets next to the container (e.g., reaction vessel) and aspirating the fluids away.

Publication No. US 2005/0013741 A1 shows such a device for separating magnetic particles from fluid volumes in a laboratory setting by using movable permanent magnets and/or reaction receptacles. Of course, each moving part generally adds to the cost and complexity of the device, as well as increasing maintenance requirements and the risk of failures. Additionally, the '741 device includes a structure in which the magnets are mounted below the receptacle, and then the magnets are moved up to the receptacle or the receptacle is moved down to the magnets, whereby the proximity of the magnets relative to the particles in the fluid may be changed to draw the particles in the receptacle one way or the other. While the use of magnets in such settings can be advantageous, in many instances this can be undesirable and disadvantageous in the restricted space of laboratory equipment. For example, with the device required to be located beneath the receptacles, the overall height of the device and the receptacle supporting trays must essentially be the combined height of the device and the receptacles, and access for maintenance can be hindered.

Of course, it should also be appreciated that testing involving chemical reactions (e.g., molecular extraction and amplification of nucleic acids such as by the polymerase chain reaction (PCR)) of substances may not be efficient or have predictable outcomes if the substances are not reliably bonded to the particles or undesirable reagents are not effectively washed away. In nucleic acid extraction, for example, a comparatively small number of molecules (e.g., 1000 molecules/mL) are required to be extracted in preparation for PCR, with such extraction in many cases being accomplished interacting with a solid phase such as magnetic particles coated with silica compounds or “bare” iron oxide particles. It can be appreciated that to bind such a small number of molecules to the solid phase, some kind of mixing may be needed to enhance the probability of encounter between a molecule (e.g., a nucleic acid molecule) and the solid phase (e.g., magnetic particle).

Such mixing of fluids, such as may be desirable, for example, to facilitate mixing or washing away of reagents during hybridization assay or nucleic acid extraction, has been heretofore accomplished mechanically in many applications, such as by shaking the fluid container and/or stirring the fluid. Shaking can, however, have high power requirements and further can be unreliable, both in the inconsistency of results as well as being subject to potential damage from the shaking. Also, mixing by stirring can use up materials. For example, stirring of biological samples by use of pipettes lowered into the fluid can cause the pipettes to be contaminated and make them unsuitable for use in subsequent processes in which the contaminated pipettes could therefore contaminate a different sample. This further results in the use of an excess number of pipettes resulting in the addition of unnecessary cost and waste to the process.

The present invention is directed toward overcoming one or more of the problems set forth above.

### SUMMARY OF THE INVENTION

In one aspect of the present invention, a tray is provided to facilitate mixing of a fluid containing magnetic or magnetizable particles, including a support for a container for the fluid and particles, a first magnet adjacent one side of the support, a second magnet adjacent the other side of the support, and a first drive for moving the second magnet between a first position on the other side which is at a distance from the fluid sufficient that the magnetic force near the bottom of the supported container is small in comparison to the force of the first magnet and a second position on the other side near the bottom of a supported container. The first magnet is supported in a third position on the one side near the bottom of a supported container and able to draw particles in the fluid to the one side of the container when the second magnet is in the first position.

A control for the first drive is adapted to move the second magnet (1) from the first position to the second position at a first rate adapted to draw the particles in the fluid in the container to the other side adjacent the second magnet, and (2) from the second position to the first position at a second rate. In some embodiments of the invention, it may be beneficial for the second rate to be substantially greater than the first rate and sufficiently fast to move the second magnet from the second position without substantially moving the particles up from near the bottom of the container.

The first magnet may be advantageously fixed in the third position, and the second magnet configured to create a stronger magnetic field in the adjacent other side than the magnetic field of the first magnet in the adjacent one side.

Additionally, a second drive can be provided to move the first magnet between the third position and a fourth position on the one side near the top of a supported container. In a further form, the control is further adapted to move the first magnet from the fourth position to the third position after the second magnet is moved from the second position to the first position. In this form, the first and second magnets may create substantially the same strength magnet fields in the sides to which they are adjacent.

In another aspect of the invention, a device for mixing magnetic or magnetizable particles suspended in a fluid in a reaction vessel is provided, including a first magnet adjacent one side of the reaction vessel, a second magnet adjacent the other side of the reaction vessel, and a drive controlling the position of the first and second magnets. The drive is adapted to move the second magnet between a first position spaced from the bottom of the reaction vessel on the other side and a second position on the other side near the bottom of a reaction vessel. The first magnet is supported in a third position on the one side near the bottom of the reaction vessel.

Advantageously, the first magnet may be fixed in the third position, and the second magnet creates a stronger magnetic field in the adjacent other side than the magnetic field of the first magnet in the adjacent one side.

In another form, the drive is adapted to move the first magnet between the third position and a fourth position on the one side near the top of a reaction vessel. In a further form, the drive is adapted to move the first magnet from the fourth position to the third position after the second magnet is moved from the second position to the first position. In a still further form, the first and second magnets create substantially the same strength magnet fields in the sides to which they are adjacent.

In still another aspect of the present invention, a device for mixing a fluid containing magnetic or magnetizable particles includes a reaction vessel containing the fluid, at least one movable magnet positioned close to the reaction vessel, and means to change the positions of the magnet relative to the reaction vessel with variable range of speeds. The range of speeds vary from speed of low values such that the magnetic or magnetizable particles are attracted to the magnet, and speed of high values, such that the magnetic or magnetic particles are unable to be attracted to the magnet.

In yet another aspect of the present invention, a method of mixing magnetic or magnetizable particles suspended in a fluid in a reaction vessel includes the steps of (a) providing a first magnet adjacent one side of the reaction vessel and a second magnet adjacent the opposite side of the reaction vessel, (b) moving the second magnet at a first rate from a first position spaced from the bottom of the reaction vessel on the opposite side to a second position on the opposite side near the bottom of the reaction vessel, the first rate being sufficiently slow to cause the particles to move through the fluid substantially toward the second magnet, and (c) moving the second magnet at a second rate from the second position to the first position, the second rate being sufficiently fast so that the particles will not significantly follow the second magnet.

In one form of this aspect, the first magnet is in a third position adjacent the one side near the bottom of the reaction vessel after step (c). In a further form, during step (a), the provided second magnet is stronger than the provided first magnet, and during steps (b) and (c) the first magnet is fixed in the third position. In an alternate form, the first magnet is maintained in a fourth position adjacent the one side near the top of the reaction vessel during steps (b) and (c), and further includes the step of moving the first magnet from the fourth position to the third position following step (c).

In another aspect of the present invention, a method is provided for magnetic capture and mixing of a reaction containing particles of magnetic or paramagnetic property, including the steps of (a) locating a first magnet in position A and a second magnet in position B with a reaction vessel having the reaction between the first and second magnets, and (b) serially moving the first magnet from position A to position C and the second magnet from position B to position D. In positions A and D the magnets render ineffective magnetic force on particles in the reaction. In position B the second magnet provides adequate magnetic force to capture particles into a pellet on one wall of the reaction vessel; and in position C the first magnet renders magnetic force adequate to attract the pellet from the one reaction vessel wall through reaction liquid and into a pellet on an opposite reaction vessel wall. The first magnet and the second magnet do not cross each other.

In one form of this aspect, positions A and C are on one side of a plane transverse to the reaction vessel and positions B and D are on the other side of the plane. In a further form, the magnets are moved in a generally vertical direction and said plane is substantially horizontal.

### BRIEF DESCRIPTION OF THE DRAWINGS

FIGS. 1a-1d are general diagrammatic views of an embodiment of Applicant's device illustrating a sequence of operation according to one aspect of the present invention;

FIGS. 2a-2d are views according to a second embodiment of the present invention; and

FIGS. 3a-3c are views illustrating a third embodiment of the present invention.

### DETAILED DESCRIPTION OF THE INVENTION

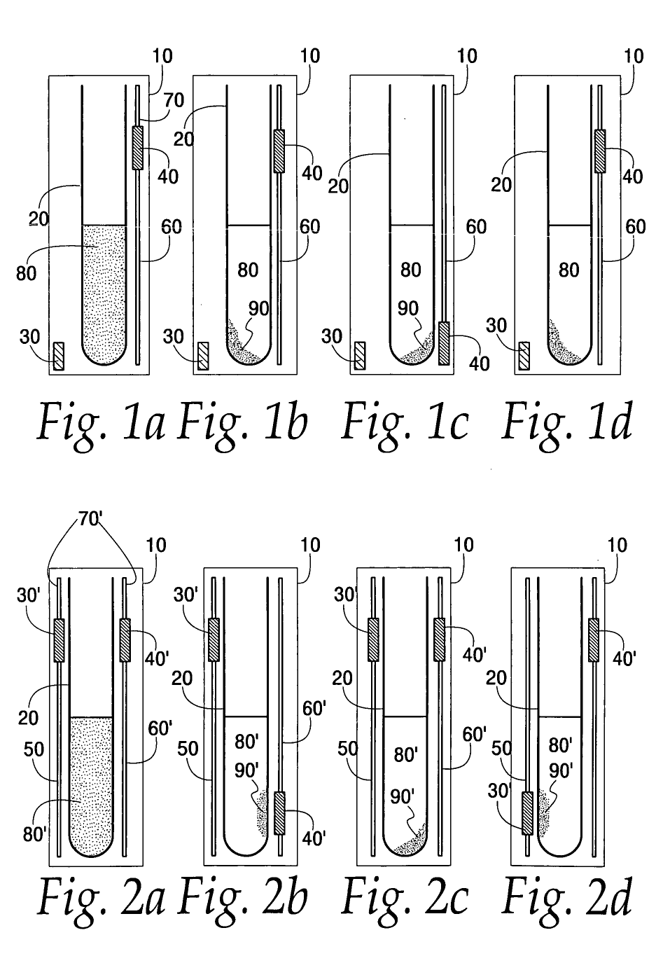

FIGS. 1a-1d and 2a-2d illustrate embodiments of the present invention, including a tray 10 which is configured to support a container, such as a reaction vessel 20. It should be appreciated that the views in the Figures are generally diagrammatic, and that any suitable structure for supporting one or more reaction vessels 20 is considered to be in accordance with the present invention, with many such structures readily known to those of ordinary skill in this art. Further, while for simplicity purposes the Figures illustrate only a single supported reaction vessel 20, it should be appreciated that a tray or other suitable support 10 capable of supporting an array of reaction vessels (e.g., trays with 8 by 12 arrays capable of supporting 96 vessels are common in PCR) is considered to be in accordance with the present invention.

FIGS. 1a-1d illustrate a first embodiment of the present invention, including a tray 10 which is configured to support a container, such as a reaction vessel 20. First and second magnets 30, 40 are suitably supported relative to the tray 10 (and supported reaction vessels 20), with the first magnet 30 fixed in a stationary position adjacent the bottom of the reaction vessel 20, and with a drive 60 provided to move the second magnet 40 along the opposite side of the vessel 20 between positions adjacent the top and bottom of the vessel 20. The second magnet 40 creates a stronger magnetic field than the first magnet 30. The relative strengths of the magnets 30, 40 may be adjusted by the choice of magnet type, and/or the positioning of the magnets 30, 40 with respect to the reaction vessel 20.

The drive 60 is provided, as illustrated diagrammatically, for moving the second magnet 40 from a position adjacent the top of the reaction vessel 20 to a position adjacent the bottom of the reaction vessel 20, as detailed below. The drive 60 may be any suitable structure which will allow the second magnet 40 to be selectively moved along the side of the reaction vessel 20 opposite the first magnet 30 in accordance with the description herein. As one example, a stepper motor having the capability of moving the second magnet 40 at one or more speeds may be used. Advantageously according to one aspect of the invention, the drive 60 does not move the magnet 40 beyond either the top or bottom of the reaction vessel 20 and therefore does not require significant additional vertical space for the tray 10.

A suitable controller 70 controls the drive 60 so that the second magnet 40 may be moved as described further below.

According to one advantageous procedure of the invention, the first magnet 30 is fixed in a position adjacent the bottom of the vessel 20 and initially functions to attract particles in the fluid toward it (as occurs between FIG. 1a and FIG. 1b). The second magnet 40 in its upper position (FIGS. 1a and 1b) is located so that whatever force its magnetic field exerts on the particles will be less than the force exerted by the first magnet 30, combined with the force of gravity, pulling the particles down. Movement of the particles through the fluid toward the first magnet 30 will cause traverse movement of the particles and thus affect fluid mixing and enhance the probability that the particles will encounter and bond with the desired substance or molecules. It should be appreciated, of course, that this action will all occur without requiring any parts to be moved.

After allowing for a period of time for the particles to move toward the first magnet 30 so that they accumulate along that side as shown at 90 in FIG. 1b, the second magnet 40 is moved down along the side of the vessel 20 whereby the stronger, second magnet 40 will cause the particles to move to the other side of the vessel 20 as shown in FIG. 1c, which forced movement of the magnetic particles through the fluid causes further mixing in the fluid, further enhancing the probability that the particles will encounter and bond with the desired substance or molecules.

Thereafter, the second magnet 40 may be moved back up to the top of the vessel 20 as shown in FIG. 1d so that the particles are not drawn up with the magnet 40 (due to inertia, viscous drag in the fluid, and gravity) and, given the proximity of the first magnet 30, the particles will be drawn back over to the other side of the vessel bottom as shown in FIG. 1d, thereby still further enhancing mixing. It should thus be appreciated that the rate of movement of the second magnet 40 up and down between the first and second positions may be at equal or different rates, and/or at constant or variable rates.

It should further be appreciated that by repetition of these steps (i.e., repeatedly moving the second magnet 40 up and down to alternate between the conditions of FIGS. 1b and 1c), further mixing may be accomplished if desired (e.g., for washing). Moreover, it may be appreciated that the motion of the second magnet 40 up to the FIG. 1d position may be at any rate and still facilitate mixing, so long as the particles are returned to the vessel bottom by a greater attraction of the first magnet 30 when the second magnet 40 is at its upper position. It should also be appreciated that the second magnet 40 may, in its remote position, not only be at the top of the vessel, but alternatively may be below the bottom of the vessel, or even laterally spaced, so long as that position is sufficiently remote that the magnetic force of the first magnet 30 will draw the particles back toward its side.

FIGS. 2a-2d illustrate, in a manner similar to FIGS. 1a-1d, another embodiment of the present invention. Objects which are identical in FIGS. 2a-2d to objects in FIGS. 1a-1d are therefore given the same reference numerals for ease of understanding, while similar but modified objects are given reference numerals with prime added (e.g., 30′).

In the second embodiment, a drive 50 is provided to also allow movement of the first magnet 30′, with both drives 50, 60′ controlled by a controller 70′ to change the position of the second magnet 40′ relative to the reaction vessel 20. In this embodiment, the magnets 30′, 40′ in particular may be moved at a variable range of speeds, varying from speeds of low values when moving the magnets 30′, 40′ from the top of the vessel 20 (FIGS. 2a, 2c) to the bottom of the vessel 20 (FIG. 2b for second magnet 40′ and FIG. 2d for first magnet 30′) to speeds of high values when moving the magnets 30′, 40′ from the bottom of the vessel 20 to the top of the vessel 20 (FIG. 2c for the second magnet 40′ and FIG. 2a for the first magnet 30′). Further, the magnets 30′, 40′ may be of differing or substantially equal strength.

In accordance with an advantageous process using the device illustrated in FIGS. 2a-2d, an initial configuration as illustrated in FIG. 2a. A reaction vessel 20 is supported in the tray 10 with a fluid 80′ in the vessel 20. Prior to processing according to the present invention, the vessel 20 begins with fluid 80′ having dispersed particles (FIG. 2a). In this home position, both of the magnets 30′, 40′ are adjacent the top of the vessel 20, preferably far enough above the fluid so that little magnetic force is imparted by the magnets 30′, 40′ on the particles in the fluid 80′.

From the initial configuration (FIG. 2a), the second magnet 40′ is moved down along the side of the vessel 20 at a first rate which is relatively slow so that, as the magnet 40′ moves down, it attracts the particles so that they are drawn over to the side of the vessel 20 adjacent to the magnet 40′, as at 90′ in FIG. 2b. This forced movement of the magnetic particles through the fluid from the dispersed condition as shown in FIG. 2a to the group along the vessel side at 90′ as shown in FIG. 2b thus causes mixing (e.g., to accommodate hybridization, washing and the like as desired) in the fluid, enhancing the probability that the particles will encounter and bond with the desired substance or molecules.

After reaching the FIG. 2b position near the bottom of the vessel 20, the magnet 40′ is then moved at a second rate back up to a position near the top of the vessel 20, as shown in FIG. 2c. The second rate may be substantially greater than the first rate and sufficiently fast to move the second magnet 40′ up without substantially moving the attracted particles 90′ up from near the bottom of the vessel 20, due to inertia and viscous drag in the fluid, as well as gravity, as previously described, all tending to keep the particles near the vessel bottom rather than being drawn back up with the second magnet 40′ as it is quickly moved away. While there will, of course, be some magnetic force applied by the magnet 40′, not only as it is driven up away from the bottom but also as it rests near the top of the vessel 20, that force will not be sufficient to overcome inertia, viscous drag and/or gravity to cause the particles to significantly follow the second magnet 40′ when moved to the vessel top at the second rate.

Thereafter, the first magnet 30′ may be driven by its drive 50 to a lowered position adjacent the other side of the reaction vessel 20 as shown in FIG. 2d. It should be appreciated that as the first magnet 30′ approaches the bottom of the vessel 20, it will start attracting the group of particles 90′ toward its side (the left side in FIG. 2d), with the further movement of the particles thereby causing further desirable mixing via movement of the particles through the fluid 80.

It should further be appreciated that by repetition of these steps (i.e., after the FIG. 2d condition, moving the first magnet 30′ back up rapidly to the FIG. 2a home position and then repeating motion of the magnets 30′, 40′ through the FIG. 2a to FIG. 2d configurations, further mixing may be accomplished if desired.

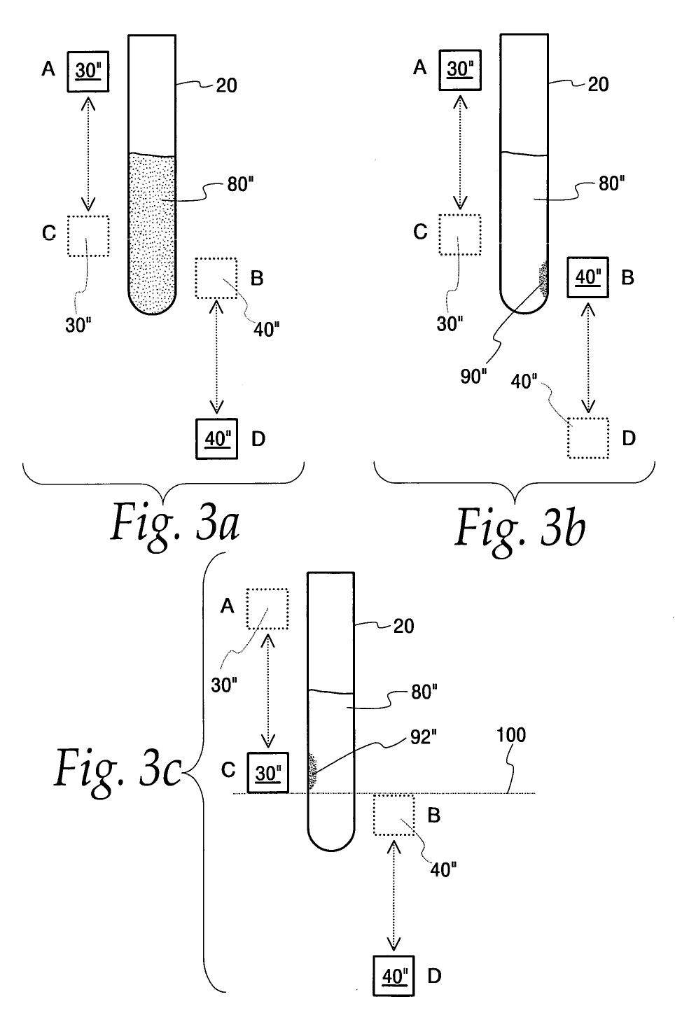

FIGS. 3a-3c illustrate still another embodiment of the present invention, wherein objects which are identical to objects in FIGS. 1a-1d are given the same reference numerals for ease of understanding, while similar but modified objects are given reference numerals with double prime added (e.g., 30″).

In this third embodiment, suitable drives and controller (not shown) are provided to also allow movement of the first magnet 30″ and second magnet 40″ relative to the reaction vessel 20. In this embodiment, the magnets 30″, 40″ may be moved at relatively constant speeds, or at a variable range of speeds such as described above with respect to the second embodiment. Further, the magnets 30″, 40″ may be of differing or substantially equal strength.

In accordance with an advantageous process using the device (see FIG. 3a), the reaction vessel 20 with a reaction or fluid 80″ therein is located with the first magnet 30″ in position A and the second magnet 40″ placed in position B (see FIG. 3b). In position A, the magnetic force rendered by the first magnet 30″ is insufficient to effect magnetic or paramagnetic particles in the fluid 80″, whereas in position B the second magnet 40″ provides a magnetic force which is adequate to capture particles in the fluid 80″ and pull them into forming a pellet 90″ on one wall of the reaction vessel 20.

After a period of time during which the particles are attracted toward the second magnet 40″ to form the pellet 90″, the first and second magnets 30″, 40″ are serially moved, with the first magnet 30″ being moved from position A to position C and the second magnet 40″ being moved from position B to position D (see FIG. 3c). In position C, the magnetic force rendered by the first magnet 30″ is adequate to attract the pellet 90″ through reaction liquid 80″ and into a pellet 92′ on an opposite wall of the reaction vessel 20. In position D, the magnetic force rendered by the second magnet 40″ is insufficient to effect magnetic or paramagnetic particles in the fluid.

Preferably, the serial movement of the magnets 30″, 40″ is such that the magnets will not have competing effects on the particles. Thus, most advantageously the first magnet 30″ will be moved away from position C before the second magnet 40″ is moved into position B, and likewise the second magnet 40″ is moved away from position B before the first magnet 30″ is moved into position C.

With this embodiment, it should be appreciated that the magnets 30″, 40″ may be advantageously moved so that their paths or levels do not cross. That is, the first magnet 30″ during its motion between positions A and C will remain on one side of a plane 100 (see FIG. 3c) which is transverse relative to the reaction vessel 20, and the second magnet 40″ during its motion between positions B and D will remain on the other side of the plane 100. Where the reaction vessel 20 is generally oriented vertically and the magnets 30″, 40″ move in a generally vertical direction along the sides of the vessel 20, the plane 100 is horizontal. It should be appreciated, however, that it would be within the broad scope of this embodiment for positions B and C to be substantially horizontally aligned.

It should also be appreciated that repetition of the described serial movement of the magnets 30″, 40″ may be repeated to accomplish further mixing if desired.

The invention contemplates not only the described apparatuses but also methods of mixing and otherwise moving magnetic or magnetizable particles suspended in a fluid in a reaction vessel. The methods can be used to mix particles to facilitate, for example, hybridization in a sample fluid, washing and the like. The invention also contemplates methods for mixing and otherwise moving magnetic or magnetizable particles suspended in a fluid in a reaction vessel. The methods can be used to mix particles to facilitate, for example, hybridization in a sample fluid, washing and the like. The methods may include, inter alia, the steps of (a) providing a first magnet adjacent one side of the reaction vessel and a second magnet adjacent the opposite side of the reaction vessel; (b) moving the second magnet at a first rate from a first position on the opposite side near the top of the reaction vessel to a second position on the opposite side near the bottom of the reaction vessel, the first rate being sufficiently slow to cause the particles to move through the fluid substantially toward the second magnet; and (c) moving the second magnet at a second rate from the second position to the first position, the second rate being sufficiently fast so that the particles will not significantly follow the second magnet. The methods may also include, inter alia, the steps described in connection with the third embodiment, in which (a) a first magnet is located in position A and a second magnet s located in position B with a reaction vessel between the magnets, and (b) serially moving the first magnet from position A to position C, and the second magnet from position B to position D, whereby (i) the magnets in positions A and D render ineffective magnetic force on particles in the reaction, (ii) the second magnet in position B provides adequate magnetic force to capture particles into a pellet on one wall of the reaction vessel, and (iii) the first magnet in position C renders magnetic force adequate to attract the pellet from the one reaction vessel wall through reaction liquid and into a pellet on an opposite reaction vessel wall, wherein the first magnet and the second magnet do not cross each other in any plane.

As can be readily appreciated, the devices and trays of the invention and their features described herein can be used to carry out the methods of mixing of the invention.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A tray to facilitate mixing of a fluid containing magnetic or magnetizable particles, comprising:
a support for a container for said fluid and particles;
a first magnet adjacent one side of the container;
a second magnet adjacent the other side of the container;
a first drive for moving said second magnet between a first position on said other side which is at a distance from the fluid sufficient that the magnetic force exerted by said second magnet near the bottom of the supported container is small in comparison to the magnetic force of the first magnet and a second position on said other side near the bottom of the supported container; and
a control for said first drive adapted to move said second magnet from said first position to said second position, and from said second position to said first position;
wherein said first magnet is supported in a third position on said one side near the bottom of the supported container.

2. The tray of claim 1, wherein
said first drive moves said second magnet from said first position to said second position at a first rate, and said first drive moves said second magnet from said second position to said first position at a second rate; and
said second rate is sufficiently high so that the viscosity of said fluid restricts movement of said particles sufficiently to prevent said particles from significantly following said second magnet when moved at said second rate.

3. The tray of claim 1, further comprising a second drive for moving said first magnet between said third position and a fourth position on said one side near the top of a supported container.

4. The tray of claim 3, wherein said control is further adapted to move said first magnet from said fourth position to said third position after said second magnet is moved from said second position to said first position.

5. A device for moving magnetic or magnetizable particles suspended in a fluid in a reaction vessel, comprising:
a first magnet adjacent one side of the reaction vessel;
a second magnet adjacent the other side of the reaction vessel;
a drive controlling the position of the first and second magnets, said drive adapted to move said second magnet between a first position spaced from the bottom of the reaction vessel on said other side and a second position on said other side near the bottom of the reaction vessel;
wherein said first magnet is supported in a third position on said one side near the bottom of the reaction vessel.

6. The device of claim 5, wherein said first magnet is fixed in said third position, and said second magnet creates a stronger magnetic field in said adjacent other side than the magnetic field of said first magnet in said adjacent one side.

7. The device of claim 5, wherein said drive is adapted to move said first magnet between said third position and a fourth position on said one side near the top of a reaction vessel.

8. A device for mixing a fluid containing magnetic or magnetizable particles, comprising:
a reaction vessel containing said fluid;
at least one movable magnet positioned close to said reaction vessel; and
means to change the positions of the magnet relative to the reaction vessel with variable range of speeds, said range of speeds varying from:
speed of low values such that said magnetic or magnetizable particles are attracted to said magnet, and
speed of high values, such that said magnetic or magnetic particles are unable to be attracted to said magnet.

9. A method of mixing magnetic or magnetizable particles suspended in a fluid in a reaction vessel, comprising the steps of:
(a) providing a first magnet adjacent one side of the reaction vessel and a second magnet adjacent the opposite side of the reaction vessel;
(b) moving said second magnet at a first rate from a first position spaced from the bottom of the reaction vessel on said opposite side to a second position on said opposite side near the bottom of the reaction vessel, said first rate being sufficiently slow to cause the particles to move through the fluid substantially toward said second magnet; and
(c) moving said second magnet at a second rate from the second position to the first position, said second rate being sufficiently fast so that the particles will not significantly follow the second magnet.

10. The method of claim 9, wherein said first magnet is in a third position adjacent the one side near the bottom of the reaction vessel after step (c).

11. The method of claim 10, wherein during step (a), said provided second magnet is stronger than said provided first magnet, and during steps (b) and (c) said first magnet is fixed in the third position.

12. The method of claim 10, wherein said first magnet is maintained in a fourth position adjacent said one side near the top of the reaction vessel during steps (b) and (c), and further comprising the step of moving said first magnet from the fourth position to the third position following step (c).

13. A method of magnetic capture and mixing of a reaction containing particles of magnetic or paramagnetic property, comprising the steps of:
locating
a first magnet in position A,
a second magnet in position B, and
a reaction vessel having the reaction between the first and second magnets,
whereby
the first magnet in position A renders ineffective magnetic force on particles in the reaction and
the second magnet in position B provides adequate magnetic force to capture particles into a pellet on one wall of the reaction vessel; and
serially moving
the first magnet from position A to position C, and
the second magnet from position B to position D, whereby
the first magnet in position C renders magnetic force adequate to attract the pellet from the one reaction vessel wall through reaction liquid and into a pellet on an opposite reaction vessel wall, and
the second magnet in position D renders ineffective magnetic force on particles in the reaction,
wherein the first magnet and the second magnet do not cross each other.

14. The method of claim 13, wherein positions A and C are on one side of a plane transverse to the reaction vessel and positions B and D are on the other side of said plane.

15. The method of claim 14, wherein said magnets are moved in a generally vertical direction and said plane is substantially horizontal.
